(19) United States
(12) Patent Application Publication
(10) Pub. No.: US 2024/0080921 A1
(43) Pub. Date: Mar. 7, 2024

(54) INFORMATION PROCESSING APPARATUS AND CONTROL METHOD

(71) Applicant: SHARP KABUSHIKI KAISHA, Osaka (JP)

(72) Inventor: HIDEKI SETO, Osaka (JP)

(21) Appl. No.: 18/140,080

(22) Filed: Apr. 27, 2023

(30) Foreign Application Priority Data
May 11, 2022 (JP) 2022-078288

(51) Int. Cl. H04W 76/14; H04L 67/54

(52) U.S. Cl. CPC H04W 76/14; H04L 67/54

(57) ABSTRACT

An information processing apparatus includes: a communicator that is wirelessly connected to another device for direct wireless communication with the other device; a recognition device that recognizes presence of a user; and a controller that controls transmission output of a radio wave output from the communicator, so as to enable wireless connection with the other device at the time when the presence of the user is recognized and to disable the wireless connection with the other device at the time when the presence of the user is no longer recognized.

### BACKGROUND OF THE INVENTION

### Field of the Invention

The present disclosure relates to an information processing apparatus and the like.

### Description of the Background Art

Some image forming apparatuses such as multi-function peripherals (MFPs, multi-function peripherals/printers) have a function to establish wireless connection with a mobile phone or a portable information terminal to print, scan, or transfer a file.

A technique for appropriately establishing wireless connection between the MFP and another device has been proposed. For example, the following technique has been proposed in the related art. In the case where a near-field communication (NFC) function is set to be enabled, operation in a direct wireless communication mode is initiated at activation to generate a service set identifier (SSID). Meanwhile, in the case where the NFC function is set to be disabled, the operation in the direct wireless communication mode is initiated in response to a user's operation instruction to generate the SSID.

Some of the MFPs have a function to establish the wireless connection with a terminal device, such as the mobile phone or a portable terminal device, to print, scan, or transfer the file. Such an MFP becomes ready for the wireless connection when being explicitly set to be ready for the wireless connection or when being set to be ready for the wireless connection in an initial status. In such a situation, when the terminal device is located in a range of a radio wave that is output from the MFP, the terminal device is wirelessly connected to the MFP.

However, in the case where the MFP and the terminal device are directly connected to each other, the terminal device is connected to a closed network environment of the MFP and the terminal device. Consequently, the terminal device is not connected to an external network such as the Internet or a mobile communication network (is disconnected from the external network). When being disconnected from the external network, the terminal device cannot use e-mails, online chat, and IP telephony, for example. In such a case, the terminal device remains disconnected from the external network until a user of the terminal device cancels the wireless connection with the MFP or until the terminal device is explicitly disconnected from the wireless connection. For this reason, for example, in the case where the MFP is ready for the wireless connection with the other device in the initial status, and the user who carries the terminal device stays in an area where the wireless connection can be established with the MFP, the terminal device is disconnected from the external network.

Accordingly, for example, in the case where the MFP is ready for the wireless connection in the initial status, and the user who carries the terminal device stays in the area where the wireless connection can be established with the MFP, the terminal device is disconnected from the external network. In the case where the user is unaware that the terminal device is disconnected from the external network and thus cannot use the e-mails, the online chat, the IP telephony, and the like, the e-mails, the online chat, the IP telephony, and the like are unavailable while the user stays in the area where the wireless connection can be established with the MFP.

Just as described, there is a problem that the terminal device cannot be connected to the external network when an information processing apparatus, such as the MFP, and the terminal device are wirelessly connected for the direct wireless communication between the information processing apparatus and the terminal device. Such a problem has not been discussed in the related art.

In view of the above-described problem, the present disclosure has a purpose of providing an information processing apparatus and the like capable of appropriately controlling wireless connection with another device.

### SUMMARY OF THE INVENTION

In order to solve the above-described problem, an information processing apparatus according to the present disclosure includes: a communicator that is wirelessly connected to another device for direct wireless communication with the other device; a recognition device that recognizes presence of a user; and a controller that controls transmission output of a radio wave output from the communicator, so as to enable wireless connection with the other device at the time when the presence of the user is recognized and to disable the wireless connection with the other device at the time when the presence of the user is no longer recognized.

A control method according to the present disclosure is a control method for an information processing apparatus that is wirelessly connected to another device for direct wireless communication with the other device, and includes: recognizing presence of a user; and controlling transmission output of a radio wave, so as to enable wireless connection with the other device at the time when the presence of the user is recognized and to disable the wireless connection with the other device at the time when the presence of the user is no longer recognized.

The present disclosure can provide the information processing apparatus and the like capable of appropriately controlling the wireless connection with the other device.

### BRIEF DESCRIPTION OF THE DRAWINGS

FIG. 1 is a view for explaining an overall configuration of a system according to a first embodiment.

FIG. 2 is a block diagram illustrating a functional configuration of an MFP according to the first embodiment.

FIG. 3 is a block diagram illustrating a functional configuration of a terminal device according to the first embodiment.

FIG. 4 is a flowchart illustrating a flow of main processing according to the first embodiment.

FIG. 5 is a flowchart illustrating a flow of wireless connection control processing according to the first embodiment.

FIGS. 6A to 6D are views illustrating an operation example in the related art and an operation example in the first embodiment.

FIG. 7 is a flowchart illustrating a flow of wireless connection control processing according to a second embodiment.

FIG. 8 is a flowchart illustrating a flow of wireless connection control processing according to a third embodiment.

FIG. 9 is a flowchart illustrating a flow of wireless connection control processing according to a fourth embodiment.

FIG. 10 is a block diagram illustrating a functional configuration of an MFP according to a fifth embodiment.

FIG. 11 is a flowchart illustrating a flow of wireless connection control processing according to the fifth embodiment.

FIG. 12 is a flowchart illustrating a flow of main processing according to a sixth embodiment.

FIG. 13 is a flowchart illustrating a flow of main processing according to a seventh embodiment.

FIG. 14 is a flowchart illustrating a flow of wireless connection control processing according to an eighth embodiment.

### DESCRIPTION OF THE PREFERRED EMBODIMENTS

A description will hereinafter be made on embodiments for carrying out the present disclosure with reference to the drawings. The following embodiments are merely examples for describing the present disclosure, and the technical scope of the disclosure set forth in the claims is not limited to the description given below.

### 1. First Embodiment

In a first embodiment, the information processing apparatus in the present disclosure is applied to an MFP 10. When a user approaches the MFP 10 in the present embodiment, the MFP 10 becomes ready for wireless connection with another device. In the present embodiment, it is assumed that a device that is wirelessly connected to the MFP 10 is a terminal device 20.

1.1 Overall Configuration

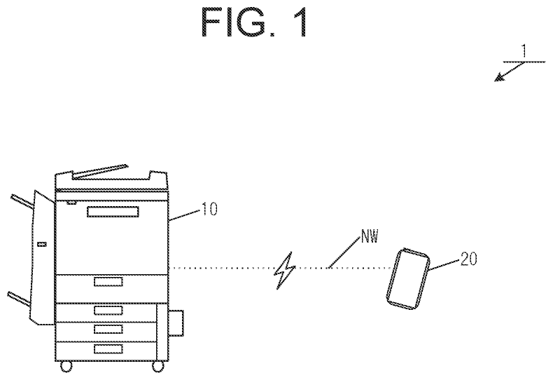

FIG. 1 is a view illustrating an overall configuration of a system 1 that includes: the MFP 10 in the present embodiment; and the terminal device 20 that is wirelessly connected to the MFP 10. The MFP 10 can be wirelessly connected to the other device, so as to create a wireless network NW for direct wireless communication. The terminal device 20 can make the direct wireless communication with the MFP 10 when being connected to the wireless network NW. An example of the wireless network NW is a wireless local area network (LAN).

The MFP 10 is an information processing apparatus (an image processing apparatus) that has a copy function, a scan function, a document print function, a facsimile function, and the like, and is also referred to as a multi-function printer/peripheral (MFP). The terminal device 20 is a terminal device (a wireless terminal) that is wirelessly connected to the MFP 10, and is a mobile phone such as a smartphone or a portable information terminal such as a tablet or a personal computer (PC), for example.

1.2 Functional Configuration

1.2.1 MFP

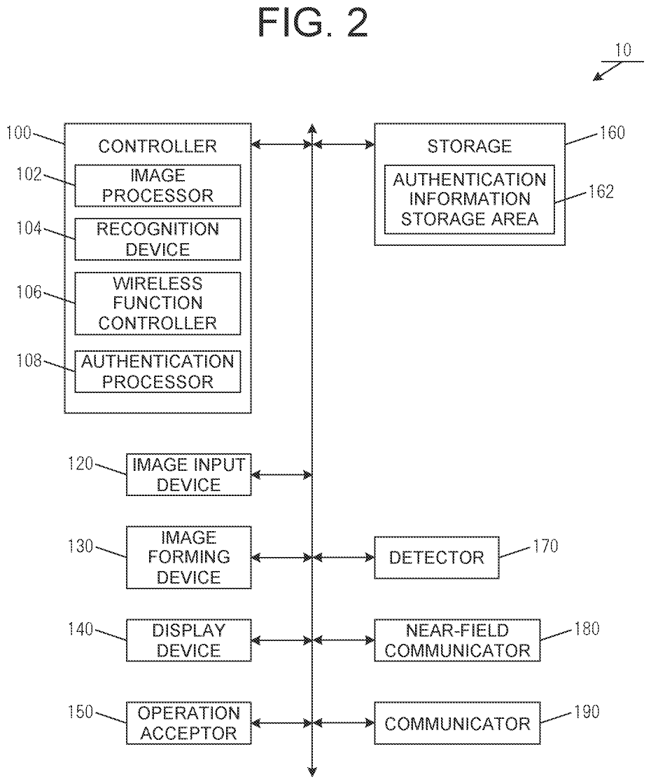

A description will be made on a functional configuration of the MFP 10 with reference to FIG. 2. The MFP 10 includes a controller 100, an image input device 120, an image forming device 130, a display device 140, an operation acceptor 150, a storage 160, a detector 170, a near-field communicator 180, and a communicator 190.

However, the MFP 10 may not include all of the above-described components. For example, in the present embodiment, the MFP 10 may not include the near-field communicator 180. In addition, a description will be made that the MFP 10 includes a user authenticator. However, the MFP 10 may not include the user authenticator. In the case where the MFP 10 does not include the user authenticator, the controller 100 may not function as an authentication processor 108, which will be described below, and the storage 160 may not have an authentication information storage area 162, which will be described below.

The controller 100 is a functional component that controls the entire MFP 10. The controller 100 reads and executes various programs that are stored in the storage 160, so as to implement various functions. For example, the controller 100 includes one or plural central processing units (CPUs). In addition, the controller 100 may be configured as a system on a chip (SoC) that has plural functions among those described below.

The controller 100 functions as an image processor 102, a recognition device 104, a wireless function controller 106, and the authentication processor 108 when executing the programs that are stored in the storage 160.

The image processor 102 executes various types of image-related processing. For example, the image processor 102 executes sharpening processing or tone conversion processing on an image that is input by the image input device 120.

The recognition device 104 recognizes presence of the user who uses the MFP 10. For example, the recognition device 104 recognizes presence of the user when the user is located around the MFP 10 or when the user is performing an operation to execute a task. Processing by the recognition device 104 will be described below.

The wireless function controller 106 controls a wireless function that is provided to the MFP 10. The wireless function is a function to establish the wireless connection with the other device and make the wireless communication with the other device. The wireless function controller 106 enables or disables the wireless function.

In addition, the wireless function controller 106 controls intensity of transmission output of a radio wave (transmission electric power) that is output from the communicator 190 for the wireless connection. For example, the wireless function controller 106 adjusts a magnitude of the electric power that is supplied to the communicator 190, and sets the intensity of the transmission output of the radio wave that is output from the communicator 190.

When the intensity of the transmission output of the radio wave, which is output from the communicator 190, is controlled, the intensity of the radio wave (radio wave intensity) that the other device receives from the MFP 10 is changed. In the case where the intensity of the radio wave that is received from the MFP 10 is sufficiently high, the other device can be wirelessly connected to the MFP 10. On the other hand, in the case where the intensity of the radio wave that is received from the MFP 10 is low, or in the case where the other device cannot receive the radio wave from the MFP 10 at all despite the presence of the other device around the MFP 10, the other device cannot be wirelessly connected to the MFP 10. Accordingly, by controlling the intensity of the transmission output of the radio wave, which is output from the communicator 190, the wireless function controller 106 can make the MFP 10 ready for the wireless connection with the other device or can disable the wireless connection with the other device.

The authentication processor 108 executes processing to authenticate the user who uses the MFP 10. In other words, the authentication processor 108 realizes the authenticator. The authentication processor 108 authenticates the user by the NFC, for example. In this case, the authentication processor 108 acquires required information for the authentication of the user from the terminal device 20 or one of a device and a card (for example, an integrated circuit (IC) card) that include information used to identify the user via the near-field communicator 180 that makes communication by using a near-field communication method. Then, the authentication processor 108 authenticates the user on the basis of the information that is acquired from the device or the card as a communication destination.

As means for authenticating the user, knowledge authentication, possession authentication, or biometric authentication may be used. The knowledge authentication is an authentication method that is based on information such as a password and a user ID. When the user is not authenticated, the authentication processor 108 may cause the display device 140 to show a screen that urges the user to perform an authenticating operation (for example, a screen that urges the user to hold the terminal device 20 over the near-field communicator 180).

The image input device 120 inputs an image to the MFP 10. For example, the image input device 120 includes a scanner device and the like. The scanner device reads a document that is placed on a document table. The scanner device converts the image into an electrical signal by using an image sensor, such as a charge coupled device (CCD) or a contact image sensor (CIS), and quantizes and encodes the electrical signal. The image input device 120 may also include an interface (a terminal) for reading out the image that is stored in Universal Serial Bus (USB) memory, may read out the image from the USB memory, and may input the image. Alternatively, the image input device 120 may receive the image from the other device via the communicator 190, so as to input the image.

The image forming device 130 forms (prints) the image on a recording medium such as recording paper. The image forming device 130 includes a print device such as a laser printer that uses an electrophotographic method. For example, the image forming device 130 feeds the recording paper from a paper feed tray that is provided to the MFP 10, then forms the image on a surface of the recording paper, and discharges the recording paper to a paper discharge tray that is provided to the MFP 10.

The display device 140 shows various types of information. The display device 140 includes a display such as a liquid crystal display (LCD), an organic electro-luminescence (EL) display, or a micro light emitting diode (LED) display.

The operation acceptor 150 accepts an operation instruction from the user who uses the MFP 10. The operation acceptor 150 includes an input device such as a key switch (a hard key) or a touch sensor. Any of common detection methods, such as a resistive method, an infrared method, an inductive method, and a capacitive method, can be adopted as a method for detecting the input through a contact (touch) by the touch sensor. Here, the MFP 10 may be mounted with a touch panel in which the display device 140 and the operation acceptor 150 are integrally formed.

The storage 160 stores various types of data and the various programs that are required for operation of the MFP 10. The storage 160 includes a storage device, such as a solid state drive (SSD) as semiconductor memory or a hard disk drive (HDD), for example.

The storage 160 has an authentication information storage area 162. In the authentication information storage area 162, authentication information that is information used for the authentication of the user is stored. For example, in the case where the user is authenticated by the NFC, the authentication information includes information on a card or a device owned by the user (for example, information that is stored in the card or the device). The authentication information may also include: information on the user (a user name and an image of the user); and information, such as the user ID and the password, that is used to authenticate the user. In the case where the possession authentication or the biometric authentication is used, the authentication information may include information on a possession of the user or biometric information of the user.

The detector 170 detects the user and an object. For example, the detector 170 outputs an infrared ray, an electromagnetic wave, or the like and receives the infrared ray, the electromagnetic wave, or the like that is reflected by the user or the object, so as to detect the user or object or to measure intensity of the reflected infrared ray, the reflected electromagnetic wave, or the like. The detector 170 may also output, to the controller 100 and the like, a signal indicating a detection result of the object or the like or a signal indicating a measurement result of the intensity of the reflected infrared ray or the like. For example, the detector 170 includes a proximity sensor that detects the object and the like, or a human-detecting sensor that detects proximity of a person. As a method for detecting the object and the like by the detector 170, a common method, such as an inductive method, the capacitive method, an ultrasonic method, an electromagnetic method, or the infrared method, can be adopted. Since the detector 170 is provided to the MFP 10, the detector 170 can detect the user who is located around the MFP 10.

The near-field communicator 180 makes near-field communication with the other device by using the near-field communication method. The near-field communicator 180 includes a communication device that is provided with an antenna, for example. Any of wireless communication methods, such as Bluetooth®, NFC, and ZigBee®, that are generally used for the near-field communication can be adopted as the near-field communication method (a wireless communication method) used by the near-field communicator 180.

The communicator 190 is connected to the other device such as the terminal device 20 for the communication with the other device. The communicator 190 includes an antenna that inputs/outputs the radio wave for the wireless connection with the other device, for example. The communicator 190 may be directly connected to the other device for the direct wireless communication with the other device. Alternatively, the communicator 190 may be connected to the wireless network and connected to the other device via the other network, such as the LAN or a wide area network (WAN), for the communication with the other device. As described above, the intensity of the transmission output of the radio wave, which is output from the communicator 190, is controlled by the wireless function controller 106.

The communicator 190 may include: the communication device such as a network interface card (NIC) that is used in the wireless LAN; and a communication module. Furthermore, the communicator 190 may be able to make wired communication in addition to the wireless communication. In such a case, the communicator 190 may include: the NIC that is used for the wired communication via a wired LAN; and an interface (a terminal) in which a cable connected to a telephone line can be plugged.

1.2.2 Terminal Device

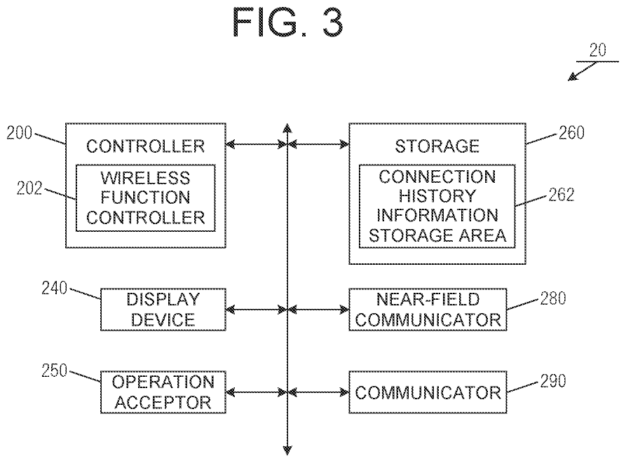

A description will be made on a functional configuration of the terminal device 20 with reference to FIG. 3. As illustrated in FIG. 3, the terminal device 20 includes a controller 200, a display device 240, an operation acceptor 250, a storage 260, a near-field communicator 280, and a communicator 290.

The controller 200 controls the entire terminal device 20. The controller 200 implements various functions by reading and executing various programs stored in the storage 260, and includes one or plural CPUs. In addition, the controller 200 may be configured as an SoC that has plural functions among those described below.

The controller 200 functions as a wireless function controller 202 by executing the program that is stored in the storage 260. The wireless function controller 202 controls the wireless function, so as to causes the terminal device 20 to implement the wireless function. For example, the wireless function controller 202 enables/disables the wireless function.

For example, the wireless function controller 202 reads out connection history information that is stored in a connection history information storage area 262 of the storage 260, and establishes the wireless connection with the device, to which the terminal device 20 has been connected wirelessly in the past. Thus, when the terminal device 20 is located in a range where the wireless connection with the device, to which the terminal device 20 has been connected in the past, is available, the wireless function controller 202 establishes the wireless connection with such a device even without the user's explicit operation for the wireless connection with the device.

The display device 240 displays various types of information. The display device 240 includes, for example: a display such as an LCD, an organic EL display, or a micro LED display; a terminal that is connected to another display and can display an image or a video on the other display; and the like.

The operation acceptor 250 accepts the operation by the user who uses the terminal device 20. The operation acceptor 250 includes an input device such as a touch sensor. The terminal device 20 may be mounted with a touch panel in which the display device 240 and the operation acceptor 250 are integrally formed.

The storage 260 stores various types of data and the various programs that are required for operation of the terminal device 20. The storage 260 includes a storage device such as an SSD as semiconductor memory, for example.

The storage 260 has the connection history information storage area 262. The connection history information is stored in the connection history information storage area 262. The connection history information is information on the other device, with to the terminal device 20 has been connected wirelessly via the communicator 290 in the past. For example, the connection history information includes: required information for the wireless connection with the other device, to which the terminal device 20 has been connected wirelessly in the past, such as an Internet Protocol (IP) address of the other device; a name of the other device; information on whether to establish the connection automatically; and the like.

The near-field communicator 280 makes the near-field communication with the other device that is located around the terminal device 20 by using the near-field communication method. The near-field communicator 280 includes a communication device that is provided with an antenna, for example. Any of the wireless communication methods, such as Bluetooth®, NFC, and ZigBee®, that are generally used for the near-field communication can be adopted as the near-field communication method used by the near-field communicator 280.

The communicator 290 is connected to the other device such as the MFP 10 via the LAN or the WAN for the communication with the other device. The communicator 290 includes: a communication device such as an NIC that is used in the wired/wireless LAN; and a communication module.

1.3 Processing Flow

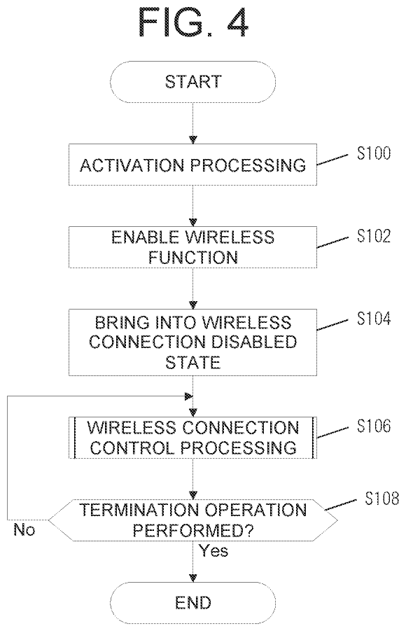

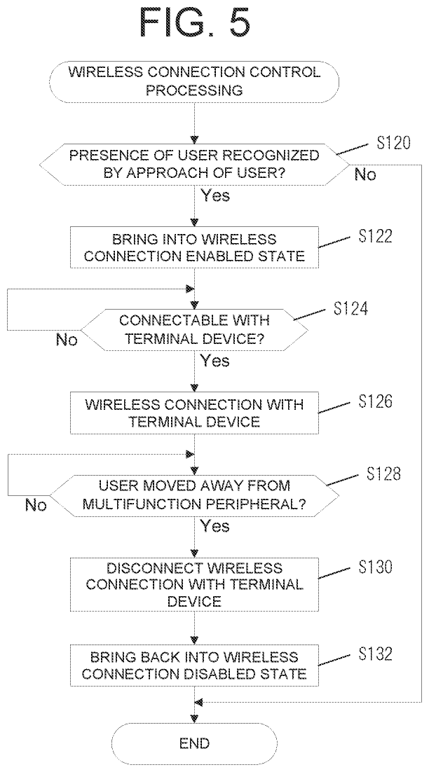

A description will be made on a flow of processing that is executed by the MFP 10 in the present embodiment with reference to FIG. 4 and FIG. 5. At timing of power-on, the controller 100 reads out the program stored in the storage 160 and executes the processing illustrated in FIG. 4 and FIG. 5. It is assumed that the detector 170 is provided to the MFP 10 and can detect the user and the like that are located around the MFP 10 (for example, in front of the MFP 10).

1.3.1 Main Processing

A description will be made on main processing that is executed by the MFP 10 with reference to FIG. 4. First, the controller 100 executes activation processing (step S100). The activation processing is processing to make the MFP 10 ready for use. For example, in the activation processing, the electric power is supplied to each of the functional components of the MFP 10, and the image forming device 130 is warmed.

Next, the controller 100 (the wireless function controller 106) enables the wireless function (step S102). To enable the wireless function means that the wireless function is implemented in the MFP 10. For example, the wireless function controller 106 adjusts the transmission output of the radio wave, which is output from the communicator 190, to such intensity that enables the wireless connection with the device existing around the MFP 10. In addition, the wireless function controller 106 makes a function, for which the wireless connection with the other device is assumed, available. As a result, the wireless function of the MFP 10 is enabled at an initial stage of the activation of the MFP 10, and thus the MFP 10 becomes ready for the wireless connection with the other device.

Next, the controller 100 (the wireless function controller 106) disables the wireless connection with the other device (step S104). To disable the wireless connection with the other device means that there is no transmission output of the radio wave, which is output from the communicator 190, (the transmission output is zero) or that the intensity of the transmission output is extremely low. For example, the wireless function controller 106 executes any of the following control for the communicator 190.
(1) The wireless function controller 106 eliminates the transmission output of the radio wave, which is output from the communicator 190, or reduces the intensity of the transmission output to be extremely low (a state of being unconnectable with the other device) while the wireless function remains enabled. In other words, the wireless function controller 106 reduces the intensity of or eliminates the transmission output of the radio wave.
(2) The wireless function controller 106 disables the wireless function.

To eliminate the transmission output of the radio wave or to reduce the intensity of the transmission output of the radio wave to be extremely low means that the wireless connection with the other device cannot practically be established although the wireless connection is enabled. To disable the wireless function means that the wireless function is not implemented in the MFP 10. For example, the wireless function controller 106 executes control to eliminate the transmission output of the radio wave from the communicator 190 by stopping the supply of the electric power to the communicator 190 or by deactivating the wireless function. In other words, when the wireless function is disabled, the MFP 10 is completely unable to establish the wireless connection with the other device. Here, the wireless function controller 106 may not allow the user to select the function, for which the wireless connection with the other device is assumed. In addition, in the case where the wireless function controller 106 disables the wireless connection with the other device by disabling the wireless function, the processing in step S102 may be omitted.

Next, the controller 100 executes the wireless connection control processing (step S106). The wireless connection control processing is processing to enable/disable the wireless connection with the other device according to whether the presence of the user is recognized by the recognition device 104. The wireless connection control processing will be described below.

Next, the controller 100 determines whether a termination operation is performed (step S108). The termination operation is an operation to terminate the use of the MFP 10. An example of the termination operation is an operation to turn off the power of the MFP 10. If the termination operation is performed, the processing illustrated in FIG. 4 is terminated (step S108; Yes). On the other hand, if the termination operation is not performed, the processing returns to step S106 (step S108; No→step S106).

1.3.2 Wireless Connection Control Processing

A description will be made on the wireless connection control processing with reference to FIG. 5. First, the controller 100 (the recognition device 104) determines whether the presence of the user is recognized by approach of the user toward the MFP 10 (step S120). For example, based on the detection result by the detector 170, the recognition device 104 recognizes the presence of the user in the following cases;
(1) when the detector 170 detects the object or the user in a predetermined range (in a range where the detector 170 can detect the object or the like);
(2) when reception intensity of the infrared ray or the like that is output from the detector 170 and reflected by the object or the like is gradually increased (when the user or the like is approaching the MFP 10); and
(3) when a distance to the object or the user detected by the detector 170 is equal to or shorter than a predetermined distance.

In other words, the recognition device 104 can recognize the presence of the user when the user approaches the MFP 10 and is located around the MFP 10. If the controller 100 (the wireless function controller 106) recognizes the presence of the user by the approach of the user, the controller 100 (the wireless function controller 106) controls the communicator 190 and enables the wireless connection with the other device (step S120; Yes→step S122). To enable the wireless connection with the other device means that the intensity of the transmission output of the radio wave, which is output from the communicator 190, is high enough to be receivable by the other device. In other words, when the wireless connection can be established, the MFP 10 is in a normal state where the MFP 10 can be connected to the other device wirelessly. For example, the wireless function controller 106 executes any of the following control for the communicator 190.
(1) The wireless function controller 106 sets the intensity of the transmission output of the radio wave, which is output from the communicator 190, to normal intensity (a normal state). In other words, the wireless function controller 106 increases the intensity of the transmission output.
(2) The wireless function controller 106 enables the wireless function and sets the intensity of the transmission output to be high enough to allow the wireless connection with the other device.

Next, the controller 100 (the wireless function controller 106) determines whether the MFP 10 can be connected to the terminal device 20 (step S124). For example, a case where the MFP 10 can be connected to the terminal device 20 corresponds to a case where the terminal device 20 is located in the range where the wireless connection can be established with the MFP 10 and the terminal device 20 requests for the wireless connection with the MFP 10.

If the MFP 10 can be connected to the terminal device 20, the controller 100 (the wireless function controller 106) establishes the wireless connection with the terminal device 20 (step S124; Yes→step S126). On the other hand, if the controller 100 (the wireless function controller 106) cannot be connected to the terminal device 20, the processing in step S124 is repeated (step S124; No).

Next, the controller 100 determines whether the user has moved away from the MFP 10 (step S128). Here, the recognition device 104 no longer recognizes the presence of the user in the following cases:
(1) when the detector 170 no longer detects the object or the user in the predetermined range (in the range where the detector 170 can detect the object or the like);
(2) when the reception intensity of the infrared ray or the like that is output from the detector 170 and reflected by the object or the like is gradually reduced (when the user or the like is moving away from the MFP 10); and
(3) when the distance to the object or the user detected by the detector 170 exceeds the predetermined distance.

In other words, the recognition device 104 can no longer recognize the presence of the user when the user moves away from the MFP 10 and is no longer located around the MFP 10. Accordingly, in the case where the recognition device 104 no longer recognizes the presence of the user, the controller 100 can determine that the user has moved away from the MFP 10.

In the case where the user moves away from the MFP 10, and the presence of the user is no longer recognized, the controller 100 (the wireless function controller 106) disconnects the MFP 10 from the wireless connection with the terminal device 20 (step S130) and disables the wireless connection with the other device again (step S132). The processing in step S132 is the same as that in step S104 illustrated in FIG. 4.

If the controller 100 determines in step S128 that the user has not moved away from the MFP 10, the processing in step S128 is repeated (step S128; No). Meanwhile, if the presence of the user is not recognized in step S120, the processing in step S122 to step S132 described above is omitted, and the processing illustrated in FIG. 5 is terminated (step S120; No).

Just as described, by executing the wireless connection control processing illustrated in FIG. 5, the controller 100 can bring the transmission output of the radio wave, which is output for the use of the wireless function, into the normal state (the state of being connectable with the other device) with the approach of the user toward the MFP 10 being a trigger. The controller 100 can also eliminate the transmission output of the radio wave, which is output for the use of the wireless function, or reduce the intensity of the transmission output to be extremely low (the state of being unconnectable with the other device) with the movement of the user away from the MFP 10 being a trigger.

1.4 Operation Example

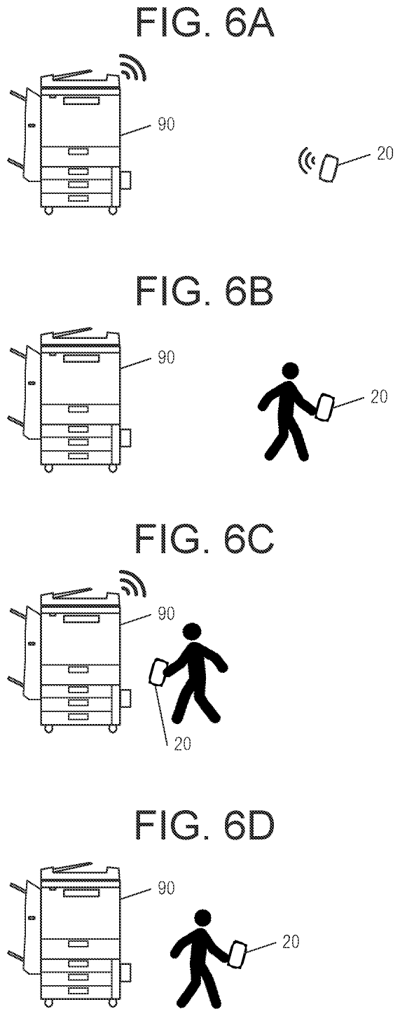

A description will be made on an operation example of the MFP, to which the information processing apparatus in the present embodiment is applied, in contrast to an operation example of the MFP, to which the information processing apparatus in the present embodiment is not applied, with reference to FIGS. 6A to 6D.

FIG. 6A is a view illustrating operation of a conventional MFP 90 that is the MFP, to which the information processing apparatus in the present embodiment is not applied. In the case of the conventional MFP 90, as illustrated in FIG. 6A, when a wireless function of the MFP 90 is enabled, the terminal device 20 (the mobile phone or the like) that has been connected to the MFP 90 wirelessly in the past is automatically connected to the MFP 90. Accordingly, in the case where the MFP 90 is installed in an office or the like, the terminal device 20, which is located around the MFP 90 (is in the range where the wireless connection can be established with the MFP 90), remains wirelessly connected to the MFP 90 until the radio wave from the MFP 90 does not reach the terminal device 20. For this reason, there is a case where the user cannot receive external communications (for example, an e-mail communication) for a long period of time.

FIG. 6B to FIG. 6D each illustrate the operation of the MFP 10, to which the information processing apparatus in the present embodiment is applied. For example, the MFP 10 recognizes the presence of the user on the basis of the detection result by the detector 170. Here, as illustrated in FIG. 6B, when the presence of the user is not recognized (for example, when the user is not approaching the MFP 10), the MFP 10 eliminates the transmission output of the radio wave for the wireless communication with the other device or reduces the intensity of the transmission output of the radio wave to be extremely low.

Next, as illustrated in FIG. 6C, when the presence of the user is recognized on the basis of the detection result by the detector 170, that is, when the user approaches the MFP 10, the MFP 10 outputs the radio wave for the wireless communication with the other device at such intensity that is high enough to be receivable by the other device. In this way, the MFP 10 can be wirelessly connected to the other device (the terminal device 20 in the example illustrated in FIG. 6C) that is located around the MFP 10.

In addition, as illustrated in FIG. 6D, when the user moves away from the MFP 10 and the presence of the user is thus no longer recognized, the MFP 10 eliminates the transmission output of the radio wave for the wireless communication with the other device or reduces the intensity of the transmission output of the radio wave to be extremely low. In this way, the terminal device 20, which has been connected to the MFP 10, is disconnected from the MFP 10 wirelessly. As a result, the terminal device 20 can be connected to the external network.

Just as described, the MFP 10 in the present embodiment can limit a period, in which the radio wave for the wireless connection with the other device is output, to a period from time at which the user approaches the MFP 10 to time at which the user moves away from the MFP 10. Thus, the MFP 10 can set a period of the direct wireless connection with the other device in a limited (intermittent) manner. In this way, the MFP 10 can avoid a state where the terminal device 20 is disconnected from the external network and thus cannot receive the external communications for the long period of time.

Here, in the case where the radio wave for the wireless connection is output at such intensity that is high enough to enable the connection with the other device, the controller 100 may limit the functions of the MFP 10, for example, by prohibiting use of the functions other than the function to receive the information from the other device.

In addition, in the above embodiment, the description has been made that the recognition device 104 recognizes the presence of the user on the basis of the detection result by the detector 170. However, the detector 170 may detect the presence of the user. In this case, the controller 100 may control the wireless function on the basis of a recognition result of the presence of the user by the detector 170.

Just as described, at the timing at which the presence of the user is recognized by the approach of the user to the MFP, the MFP in the present embodiment brings the transmission output of the radio wave for the wireless connection into the normal state (a state where the wireless connection is made available). Furthermore, in the case where the presence of the user is no longer recognized due to movement of the user away from the MFP even after the intensity of the transmission output of the radio wave for the wireless connection is brought into the normal state, the MFP in the present embodiment eliminates the transmission output of the radio wave for the wireless connection or reduces the intensity of the transmission output of the radio wave to be extremely low. As a result, the period in which the terminal device possessed by the user is wirelessly connected to the MFP and makes the direct wireless communication is limited. Since the period in which the terminal device possessed by the user and the MFP make the direct wireless communication is set in the limited manner, the terminal device cannot make the communication (for example, the communication such as the email or chat from the outside) via the external network is disabled only temporarily. Just as described, the MFP according to the present embodiment can avoid the continuous wireless connection between the MFP and the terminal device from being maintained, and thus can prevent the extension of the period in which the terminal device cannot be connected to the Internet or the mobile communication network (cannot make the external communication).

Here, in the related art, there is a problem that, in the case where the wireless connection is not appropriately terminated, the terminal device, such as the portable terminal or the portable information terminal, remains connected to the MFP, which extends a period in which the terminal device cannot be connected to the Internet or the mobile communication network (cannot make the external communications). There is also a problem that, in order to terminate the wireless connection, the user has to perform an operation to press a button or the like on the terminal device, such as the portable terminal or the portable information terminal, so as to disconnect from the wireless connection, or has to perform an operation to disconnect from the wireless connection from the other device such as the MFP. Furthermore, when the wireless function is enabled again, it is required to dynamically generate the SSID, or it is required for the user to set the SSID and a passcode at the time of generating the SSID. Moreover, there is a problem that, when the SSID is changed, a preparation period for the direct wireless connection (access point mode communication) is required.

The MFP in the present embodiment solves these problems. Since the MFP appropriately controls the transmission output of the radio wave, which is used for the wireless connection, the period in which the terminal device cannot make the external communication is shortened, and the user's operation to disconnect from the wireless connection is not required. In addition, the MFP in the present embodiment controls the transmission output of the radio wave while the wireless function remains enabled. In this way, it is possible to maintain the wireless function (a wireless module) in an activated state. As a result, the SSID of the MFP in the present embodiment is not changed, which eliminates the need for the setting of the SSID and the passcode.

### 2. Second Embodiment

Next, a second embodiment will be described. The second embodiment differs from the first embodiment in that, in an MFP using a near-field communication method, the wireless function is controlled on the basis of a detection result of the other device by using a near-field communication method.

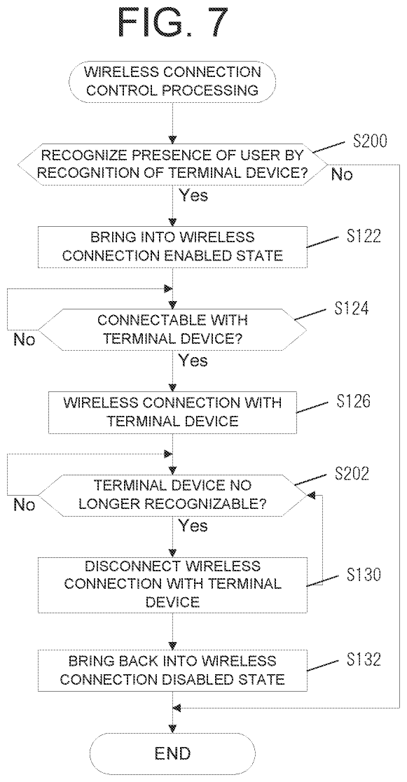

The present embodiment is implemented by replacing FIG. 5 in the first embodiment with FIG. 7. The same processing as that in the first embodiment will be denoted by the same reference sign, and the description thereon will not be made. In addition, the MFP 10 in the present embodiment does not have to include all the components illustrated in FIG. 2 of the first embodiment. For example, in the present embodiment, the MFP 10 may not include the detector 170.

In the present embodiment, the recognition device 104 recognizes the presence of the user when the near-field communicator 180 recognizes the other device (detects the presence of the other device) by the near-field communication method using the NFC, Bluetooth®, or the like.

Next, a description will be made on processing that is executed by the controller 100 in the present embodiment. The description in the present embodiment will be made on the assumption that the other device recognized by the recognition device 104 is the terminal device 20.

In the present embodiment, the controller 100 executes the processing in step S100 to step S104 in the main processing illustrated in FIG. 4, and enables the wireless function in advance at the initial stage of the activation of the MFP 10. In other words, the controller 100 (the wireless function controller 106) activates the wireless function in advance, and then eliminates the transmission output of the radio wave, which is output from the communicator 190, or reduces the intensity of the transmission output of the radio wave to be extremely low. Thereafter, the controller 100 executes the wireless connection control processing in step S106.

A description will be made on the wireless connection control processing in the present embodiment with reference to FIG. 7. First, the controller 100 (the recognition device 104) determines whether the presence of the user is recognized on the basis of the recognition of the terminal device 20 by the near-field communicator 180 using the near-field communication method (step S200). If the presence of the user is recognized on the basis of the recognition of the terminal device 20, the controller 100 (the wireless function controller 106) controls the communicator 190 to enable the wireless connection with the other device (step S200; Yes→step S122).

Thereafter, after being wirelessly connected to the terminal device 20, the controller 100 determines whether the terminal device 20 can no longer be recognized (step S202). Here, the recognition device 104 can no longer recognize the presence of the user when the near-field communicator 180 can no longer recognize the terminal device 20. Accordingly, in the case where the recognition device 104 no longer recognizes the presence of the user, the controller 100 can determine that the terminal device 20 can no longer be recognized.

If the terminal device 20 can no longer be recognized, and thus the presence of the user is no longer recognized, the controller 100 (the wireless function controller 106) disconnects the MFP 10 from the wireless connection with the terminal device 20 (step S202; Yes→step S130) and disables the wireless connection with the other device again (step S132).

On the other hand, if the terminal device 20 keeps being recognized in step S202, the processing in step S202 is repeated (step S202; No). Meanwhile, if the terminal device 20 is not recognized, and thus the presence of the user is not recognized in step S200, the processing in step S122 to step S132 described above is omitted, and the processing illustrated in FIG. 7 is terminated (step S200; No).

By executing the above-described processing, when the terminal device 20 is located in a predetermined range (a range where the near-field communication can be made with the terminal device 20), the controller 100 determines that the user is located around the MFP 10 and brings the transmission output of the radio wave for the wireless connection into the normal state (the state where the wireless connection is made available). In addition, even after the transmission output of the radio wave for the wireless connection is brought into the normal state, the controller 100 can eliminate the transmission output of the radio wave for the wireless connection or reduce the intensity of the transmission output of the radio wave for the wireless connection to be extremely low at the time when the terminal device 20 is no longer located in the predetermined range (the range where the near-field communication can be made with the terminal device 20) and thus the presence of the user is no longer recognized.

The processing illustrated in FIG. 7 is the processing to make the MFP 10 ready for the wireless connection when the MFP 10 recognizes the terminal device 20. However, the MFP 10 may become ready for the wireless connection when receiving a wireless connection request from the terminal device 20. In this case, in step S200 illustrated in FIG. 7, the controller 100 recognizes the terminal device 20 and determines whether the wireless connection request is received from the terminal device 20. Then, when the terminal device 20 is recognized, and the wireless connection request is received from the terminal device 20, the wireless function controller 106 enables the wireless connection. The wireless connection request can be any information or signal in a predetermined format.

Just as described, the MFP in the present embodiment recognizes the presence of the user by recognizing the terminal device (the mobile phone or the portable information terminal), which is held by the user, using the near-field communication method such as the NFC or Bluetooth®, for example. Then, with the recognition of the presence of the user being a trigger, the MFP in the present embodiment brings the transmission output of the radio wave for the wireless connection into the normal state (the state of being connectable with the other device). Thereafter, with a fact that the terminal device held by the user can no longer be recognized by the NFC or Bluetooth® and thus the presence of the user is no longer recognized being a trigger, the MFP in the present embodiment eliminates the transmission output of the radio wave for the wireless connection or reduces the intensity of the transmission output of the radio wave for the wireless connection to be extremely low (the state of being unconnectable with the other device) again. In this way, the MFP in the present embodiment enables the wireless connection only when the terminal device possessed by the user is located within the range where the near-field communication can be made with the MFP. Thus, it is possible to limit the period in which the MFP can be wirelessly connected to the terminal device. As a result, the MFP in the present embodiment can avoid continuation of the state where the terminal device possessed by the user cannot receive the external communications for the long period of time.

### 3. Third Embodiment

Next, a third embodiment will be described. The third embodiment differs from the first embodiment in that, in the MFP having the user authenticator, the wireless function is controlled on the basis of a user authentication status and a use status of the MFP by the user.

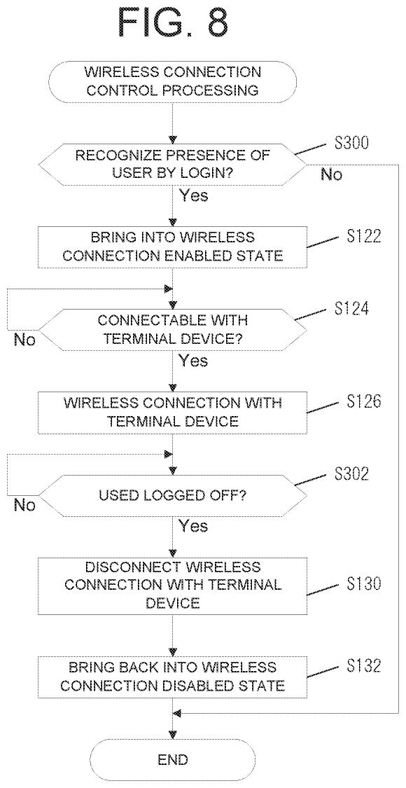

The present embodiment is implemented by replacing FIG. 5 in the first embodiment with FIG. 8. The same processing as that in the first embodiment will be denoted by the same reference sign, and the description thereon will not be made. In addition, the MFP 10 in the present embodiment does not have to include all the components illustrated in FIG. 2 of the first embodiment. In the present embodiment, the MFP 10 may not include the detector 170 and the near-field communicator 180.

In the present embodiment, the controller 100 functions as the authentication processor 108. In addition, the storage 160 has the authentication information storage area 162, and the authentication information of the user who uses the MFP 10 is stored in advance in the authentication information storage area 162.

When the authentication processor 108 authenticates the user, the controller 100 causes the user to log into the MFP 10. Furthermore, the user who has logged in performs a logoff operation, the controller 100 causes the user to log off the MFP 10. The controller 100 may have an automatic logoff function to cause the user to log off when the user who has logged into the MFP 10 does not perform the operation for a certain period of time.

The recognition device 104 recognizes the presence of the user when the user is authenticated and logs into the MFP 10. The recognition device 104 may no longer recognize the presence of the user when the user logs off the MFP 10. In this case, the recognition device 104 recognizes the presence of the user in a period from time at which the user logs into the MFP 10 to time at which the user logs off the MFP 10.

Next, a description will be made on processing that is executed by the controller 100 in the present embodiment. In the present embodiment, the user authenticator that is realized by the authentication processor 108 is enabled.

In the present embodiment, the controller 100 executes the processing in step S100 to step S104 in the main processing illustrated in FIG. 4. The controller 100 enables the wireless function in advance at the initial stage of the activation of the MFP 10, and then eliminates the transmission output of the radio wave, which is output from the communicator 190, or reduces the intensity of the transmission output of the radio wave to be extremely low. Thereafter, the controller 100 executes the wireless connection control processing in step S106.

A description will be made on the wireless connection control processing in the present embodiment with reference to FIG. 8. First, the controller 100 (the recognition device 104) determines whether the presence of the user is recognized by the login of the user into the MFP 10 (step S300). If the presence of the user is recognized by the login of the user into the MFP 10, the controller 100 (the wireless function controller 106) controls the communicator 190 and makes the MFP 10 ready for the wireless connection with the other device (step S300; Yes→step S122).

After the wireless connection with the terminal device 20 is established, the controller 100 determines whether the user has logged off (step S302). Here, in the case where the user has performed the operation to log off, or the user has logged off by the automatic logoff function, the recognition device 104 no longer recognizes the presence of the user.

If the presence of the user is no longer recognized by the logoff of the user, the controller 100 (the wireless function controller 106) disconnects the wireless connection with the terminal device 20 (step S302; Yes→step S130) and disables the wireless connection again (step S132).

If the user has not logged off in step S302, the processing in step S302 is repeated (step S302; No). Meanwhile, in step S300, if the presence of the user is not recognized due to absence of the login of the user to the MFP 10, the processing in step S122 to step S132 described above is omitted, and the processing illustrated in FIG. 8 is terminated (step S300; No).

In the present embodiment, the description has been made on that the user is authenticated by the MFP 10. However, the user may be authenticated by a device other than the MFP 10. In this case, in step S300 illustrated in FIG. 8, the recognition device 104 may recognize the presence of the user on the basis of whether the user is authenticated by the device that authenticates the user.

In addition, the above description has been made that, when the user logs off and the presence of the user is no longer recognized, the wireless connection is disabled again. However, the wireless function controller 106 may disable the wireless connection again in the case where the user's task is completed. Examples of the case where the user's task is completed is a case where there is no more operation by the user and, more specifically, a case where the user's task is completed is a case where a predetermined task or processing is executed by the user and a case where the user does not input the operation for a certain period of time.

Just as described, with the authentication of the user by using the authenticator such as the NFC being a trigger, the MFP in the present embodiment can bring the transmission output for the wireless connection into the normal state (the state of being connectable with the other device). In addition, with the logoff of the authenticated user being a trigger, the MFP in the present embodiment can eliminate the transmission output for the wireless connection or reduce the intensity of the transmission output for the wireless connection to be extremely low (the state of being unconnectable with the other device) again.

Furthermore, the MFP in the present embodiment causes the user to log off by the automatic logoff function after a lapse of the certain period of time. Thus, at such timing, the MFP in the present embodiment can eliminate the transmission output for the wireless connection or reduce the intensity of the transmission output for the wireless connection to be extremely low again. Accordingly, even in the case where the user forgets to perform the logoff operation, the wireless connection with the MFP is disabled after the lapse of the certain period of time. Therefore, it is possible to prevent the continuation of the state where the terminal device possessed by the user cannot receive the external communications.

### 4. Fourth Embodiment

Next, a fourth embodiment will be described. The fourth embodiment differs from the first embodiment in that the wireless function is controlled in an MFP having a function to display an image that shows information used for the wireless connection with the other device such as the terminal device.

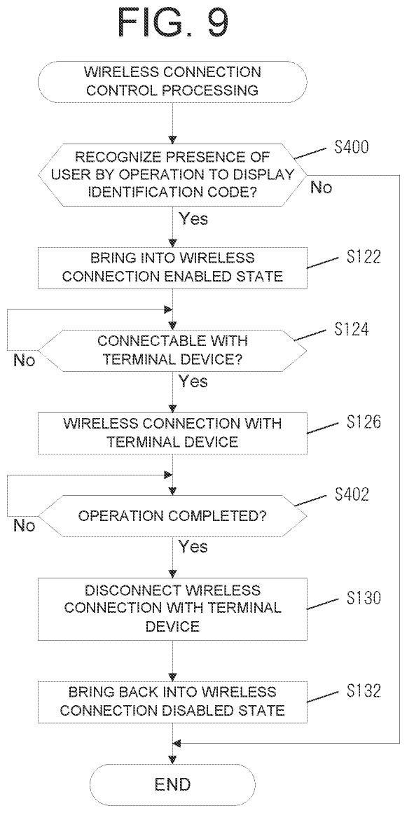

The present embodiment is implemented by replacing FIG. 5 in the first embodiment with FIG. 9. The same processing as that in the first embodiment will be denoted by the same reference sign, and the description thereon will not be made. In addition, the MFP 10 in the present embodiment does not have to include all the components illustrated in FIG. 2 of the first embodiment. For example, in the present embodiment, the controller 100 may not include the detector 170 and the near-field communicator 180.

In the present embodiment, the image that shows the information used for the wireless connection is an image that encodes information used for the wireless connection with the other device such as the terminal device 20, and is also referred to as an identification code. The identification code is a two-dimensional code such as a QR Code®. The identification code may be a two-dimensional code such as a micro QR code, DataMATRIX, VeriCODE, or PDF417, may be a one-dimensional code, or may be a monochrome image or a color image that encodes the information in a predetermined format. Examples of the information used for the wireless connection are: the SSID that is used for the direct wireless connection with the MFP 10; and information on a name, an address such as an Internet protocol (IP) address, and a security type of the MFP 10.

The recognition device 104 recognizes the presence of the user when the user starts performing the operation to execute the task. The task is processing that uses the function (the copy function, the scan function, the document print function, the facsimile function, or the like) provided to the MFP 10. The operation to execute the task is an operation to select the function to be implemented, an operation to set the function to be implemented, or an operation to instruct implementation. In particular, in the present embodiment, time at which the operation to display the identification code is performed is regarded as time at which the operation to execute the task is started. Then, in such time, the recognition device 104 recognizes the presence of the user.

The recognition device 104 may no longer recognize the presence of the user when the operation to execute the task is completed. Examples of the time when the operation to execute the task is completed are: time when the execution of the task is instructed; and time when the execution of the task is completed. However, when a certain period of time elapses from the last operation input (when there is no more user's operation), it may be considered that the operation to execute the task is completed. Then, in such time, the recognition device 104 may no longer recognize the presence of the user.

In other words, the recognition device 104 recognizes the presence of the user in a period from time at which the operation to display the identification code is performed to time at which the operation to execute the task is completed.

Next, a description will be made on processing that is executed by the controller 100 in the present embodiment. In the present embodiment, the controller 100 executes the processing in step S100 to step S104 in the main processing illustrated in FIG. 4, enables the wireless function in advance at the initial stage of the activation of the MFP 10, and eliminates the transmission output of the radio wave, which is output from the communicator 190, or reduces the intensity of the transmission output of the radio wave to be extremely low. Thereafter, the controller 100 executes the wireless connection control processing in step S106.

A description will be made on the wireless connection control processing in the present embodiment with reference to FIG. 9. First, the controller 100 (the recognition device 104) determines whether the presence of the user is recognized by the operation to display the identification code (step S400). In the case where the operation to display the identification code is performed, the controller 100 displays the identification code on the display device 140.

If the presence of the user is recognized by the operation to display the identification code, the controller 100 (the wireless function controller 106) controls the communicator 190 and makes the MFP 10 ready for the wireless connection with the other device (step S400: Yes→step S122).

Then, after the wireless connection with the terminal device 20 is established, the controller 100 determines whether the operation to execute the task is completed (step S402). Here, when the operation to execute the task is completed, the recognition device 104 no longer recognizes the presence of the user.

If the presence of the user is no longer recognized by the termination of the operation to execute the task, the controller 100 (the wireless function controller 106) disconnects the wireless connection with the terminal device 20 (step S402; Yes→step S130) and disables the wireless connection again (step S132).

In the above description, the time at which the operation to display the identification code is performed is regarded as the time at which the operation to execute the task is started. However, the time at which the operation to execute the task is started may be other than the time at which the operation to display the identification code is performed. In other words, the time at which the operation to execute the task is started may be determined in advance or may be settable by the user of the MFP 10. In addition, since it is determined that the operation to execute the task is performed when the operation acceptor 150 is operated, the recognition device 104 may recognizes the presence of the user in a period from time at which the operation acceptor 150 starts being operated to time at which the operation acceptor 150 remains unoperated for a certain period of time.

Just as described, the MFP in the present embodiment can recognize the presence of the user when the operation is performed to display the identification code for the wireless connection with the terminal device. Thus, the MFP in the present embodiment can bring the transmission output of the radio wave for implementing the wireless function into the normal state. In addition, when the presence of the user is no longer recognized by the termination of the operation to execute the task, the MFP in the present embodiment can eliminate the transmission output of the radio wave for implementing the wireless function or reduce the intensity of the transmission output of the radio wave to be extremely low (the state of being unconnectable with the other device) again.

### 5. Fifth Embodiment

Next, a fifth embodiment will be described. The fifth embodiment differs from the first embodiment in that the wireless function is controlled in an MFP having an image recognition function.

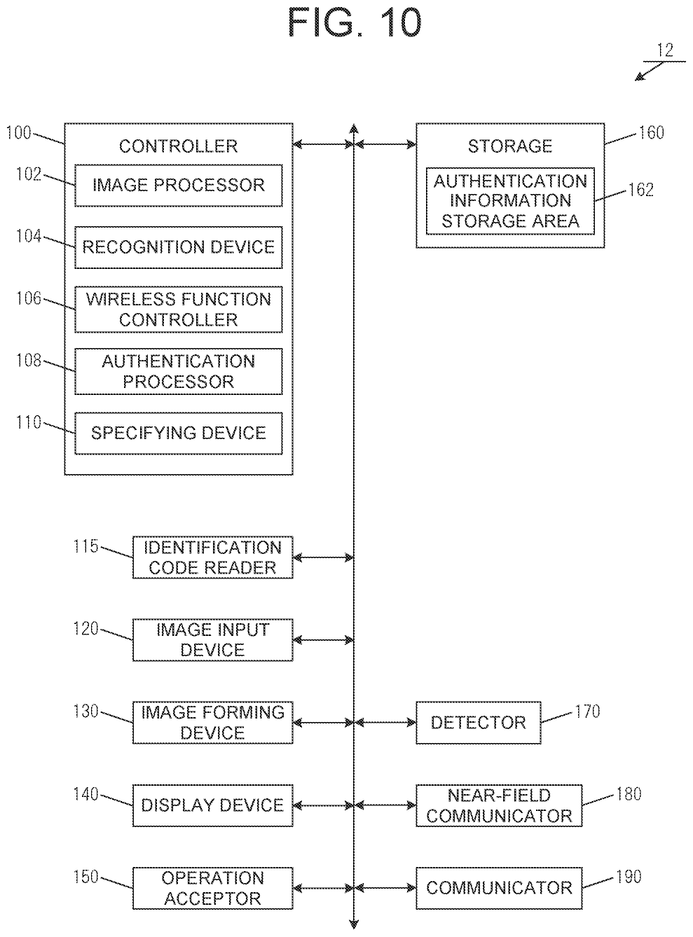

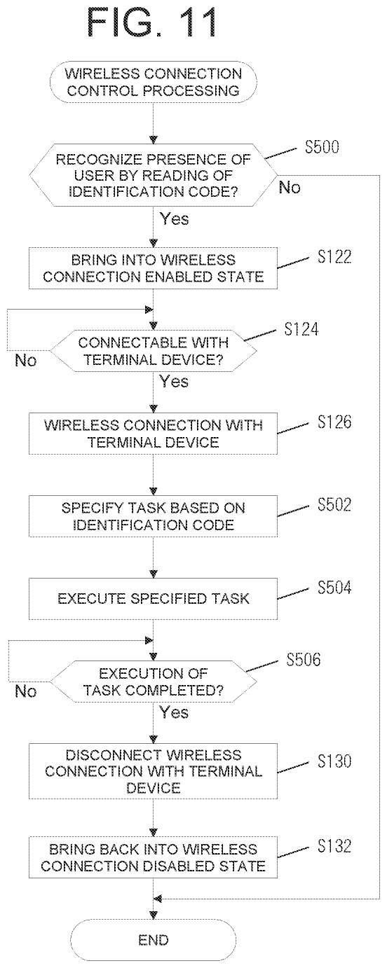

In the present embodiment, FIG. 2 in the first embodiment is replaced with FIG. 10, and FIG. 5 in the first embodiment is replaced with FIG. 11. The same functional components and the same processing as those in the first embodiment will be denoted by the same reference signs, and the description thereon will not be made. In addition, the MFP 10 in the present embodiment may not include all the components illustrated in FIG. 2 of the first embodiment. In the present embodiment, the MFP 10 may not include the detector 170 and the near-field communicator 180.

5.1 Functional Configuration

A description will be made on a functional configuration of an MFP 12 in the present embodiment with reference to FIG. 10. The MFP 12 includes an identification code reader 115 that reads the identification code, in addition to the components of the MFP 10 illustrated in FIG. 2. The identification code in the present embodiment is an image that encodes information on a content of the task to be executed by the MFP 10 and a setting of the task. Examples of the identification code are: the two-dimensional code or the one-dimensional code indicating a predetermined piece of information; and the monochrome image or the color image that encodes such a piece of the information in the predetermined format. For example, the identification code reader 115 includes a QR code reader, an optical barcode reader, or the like.

For example, the identification code is displayed on the display device 240 of the terminal device 20. In this case, in the terminal device 20, an application for displaying the identification code, which is readable by the MFP 12, is stored in the storage 260 in advance. Then, when the controller 200 executes the application on the basis of the user's operation, the identification code is displayed on the display device 240. The terminal device 20 may acquire the identification code from another device that is connected to the MFP 12 or the Internet, and may display the acquired identification code on the display device 240. In this case, the identification code reader 115 may read the identification code that is displayed on the display device 240.

The controller 100 of the MFP 12 functions as a specifying device 110. The specifying device 110 executes image recognition of the identification code to specify the task that is indicated by the identification code.

In the MFP 12, instead of providing the identification code reader 115, the image input device 120 may read the identification code. In this case, the image input device 120 may scan and read the identification code that is printed on the recording medium such as printing paper.

In addition, the recognition device 104 recognizes the presence of the user when the user starts performing the operation to execute the task. In particular, in the present embodiment, time when the identification code reader 115 reads the identification code is considered as time when the operation to execute the task is started. Then, in such time, the recognition device 104 recognizes the presence of the user. Here, time when the specifying device 110 executes the image recognition of the identification code or time when the task may be specified is considered as the time when the user starts the operation to execute the task. Then, in such time, the recognition device 104 may recognize the presence of the user. Thereafter, the recognition device 104 may no longer recognize the presence of the user when the operation to execute the task, which is specified by the specifying device 110, is terminated (for example, when the execution of the task is instructed, when the execution of the task is completed, or when there is no more user's operation).

5.2 Processing Flow

Next, a description will be made on processing that is executed by the controller 100 in the present embodiment. In the present embodiment, the controller 100 executes the processing in step S100 to step S104 in the main processing illustrated in FIG. 4, enables the wireless function in advance at the initial stage of the activation of the MFP 10, and eliminates the transmission output of the radio wave, which is output from the communicator 190, or reduces the intensity of the transmission output of the radio wave to be extremely low. Thereafter, the controller 100 executes the wireless connection control processing in step S106.

A description will be made on the wireless connection control processing in the present embodiment with reference to FIG. 11. First, the controller 100 (the recognition device 104) determines whether the presence of the user is recognized by reading of the identification code (step S500).

If the presence of the user is recognized by reading of the identification code, the controller 100 (the wireless function controller 106) controls the communicator 190 and makes the MFP 12 ready for the wireless connection with the other device (step S500: Yes→step S122).

Thereafter, the wireless connection with the terminal device 20 is established, and the identification code, which is read in step S500, is subjected to the image recognition. In this way, the controller 100 (the specifying device 110) specifies the task indicated by the identification code (step S502). Then, the controller 100 executes the task that is specified in step S502 (Step S504).

Next, the controller 100 determines whether the task, which is executed in step S504, is completed (step S506). Here, in the case where the execution of the task, which is specified by the specifying device 110 on the basis of the identification code, is completed, the recognition device 104 no longer recognizes the presence of the user.

If the presence of the user is no longer recognized by the completion of the task, the controller 100 (the wireless function controller 106) disconnects the wireless connection with the terminal device 20 (step S506; Yes→step S130) and disables the wireless connection again (step S132).

On the other hand, if the execution of the task is not completed in step S506, the processing in step S506 is repeated (step S506; No). Meanwhile, in step S500, if the presence of the user is not recognized due to failure in reading of the identification code, the processing in step S122 to step S132 described above is not executed, and the processing illustrated in FIG. 11 is terminated (step S500; No).

The description has been made above that the recognition device 104 no longer recognizes the presence of the user when the execution of the task is completed. However, the recognition device 104 may no longer recognize the presence of the user when the execution of the task is instructed or when there is no more user's operation.

Just as described, in the MFP in the present embodiment, it is possible to recognize the presence of the user by recognizing the image such as the identification code, and it is thus possible to bring the transmission output of the radio wave for implementing the wireless function into the normal state. In addition, when the presence of the user is no longer recognized due to the completion of the task, which is indicated by the identification code, the MFP in the present embodiment can eliminate the transmission output of the radio wave for implementing the wireless function or reduce the transmission output of the radio wave to be extremely low (the state of being unconnectable with the other device) again.

### 6. Sixth Embodiment

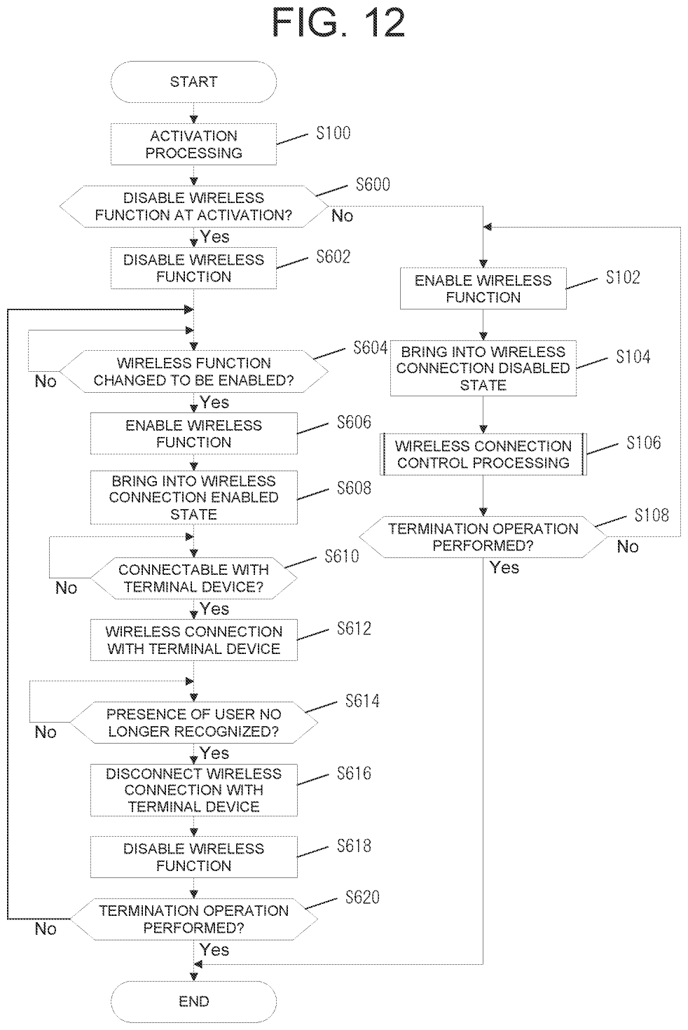

Next, a sixth embodiment will be described. In the sixth embodiment, the MFP in the first embodiment further has a function to set whether to enable/disable the wireless function at the activation, and controls the wireless function. The present embodiment is implemented by replacing FIG. 4 in the first embodiment with FIG. 12.

The MFP 10 in the present embodiment has the function to set whether to enable/disable the wireless function at the activation. For example, based on the user's operation, the controller 100 displays, on the display device 140, a setting screen for setting whether to enable/disable the wireless function at the activation. In this case, when the user performs an operation to set whether to enable/disable the wireless function at the activation, the controller 100 stores information on whether to enable/disable the wireless function at the activation in the storage 160 on the basis of the operation.

However, the method for setting whether to enable/disable the wireless function at the activation is not limited to the above-described method. For example, it may be configured that another device (for example, a server device that manages the MFP 10, or the like) communicable with the MFP 10 can set whether to enable/disable the wireless function at the activation of the MFP 10 and that the MFP acquires a content of the setting from the other device. Alternatively, the MFP 10 may include a switch that can be used to set whether to enable/disable the wireless function at the activation, and the MFP 10 may enable or disable the wireless function at the activation according to an operation of the switch.

Next, a description will be made on a flow of main processing that is executed by the controller 100 with reference to FIG. 12. First, the controller 100 executes the activation processing (step S100).

Next, the controller 100 (the wireless function controller 106) determines whether to disable the wireless function at the activation (step S600). For example, the wireless function controller 106 acquires the information on whether to enable/disable the wireless function at the activation by reading such information from the storage 160 or by receiving such information from the other device. Then, the wireless function controller 106 determines whether to disable the wireless function at the activation on the basis of the acquired information.

If determining in step S600 to disable the wireless function at the activation, the controller 100 (the wireless function controller 106) disables the wireless function (step S600; Yes→step S602).

Next, the controller 100 (the wireless function controller 106) determines whether the user has enabled the wireless function (step S604). If the user has enabled the wireless function, the controller 100 (the wireless function controller 106) enables the wireless function (step S604; Yes→step S606). For example, the wireless function controller 106 brings the transmission output of the radio wave, which is output from the communicator 190, into the normal state or makes a function, for which the wireless connection with the other device is assumed, available. On the other hand, if the user has not enabled the wireless function, the processing in step S604 is repeated (step S604; No).

Next, the controller 100 (the wireless function controller 106) enables the wireless connection with the other device can be established (step S608). If the MFP 10 is connectable with the terminal device 20, the controller 100 (the wireless function controller 106) establishes the wireless connection with the terminal device 20 (step S610; Yes→step S612). On the other hand, if the MFP 10 is unconnectable with the terminal device 20, the processing in step S610 is repeated (step S610; No). The processing in Step S608 to Step S612 is the same as the processing in Step S122 to Step S126 in FIG. 5.

Next, the controller 100 determines whether the presence of the user is no longer recognized by the recognition device 104 (step S614). Examples of the case where the presence of the user is no longer recognized are: a case where the user moves away from the MFP 10; the case where the terminal device 20 can no longer be recognized by the near-field communicator 180; and the case where the operation to execute the task is completed.

If the presence of the user is recognized, the processing in step S614 is repeated (Step S614; No). On the other hand, if the presence of the user is no longer recognized, the controller 100 (the wireless function controller 106) disconnects the wireless connection with the terminal device 20 (step S614; Yes→step S616) and disables the wireless function (step S618).

Next, the controller 100 determines whether the termination operation is performed (step S620). If the termination operation is performed, the processing illustrated in FIG. 12 is terminated (step S620; Yes). On the other hand, if the termination operation is not performed, the processing returns to step S604 (step S620; No→step S604).

Just as described, the controller 100 (the wireless function controller 106) executes the processing in step S600 to step S620 described above. In this way, in the case where the presence of the user is no longer recognized after the wireless function is switched to be enabled from being disabled, the controller 100 (the wireless function controller 106) can disable the wireless function.

Meanwhile, if the controller 100 enables the wireless function at the activation, similar to the first embodiment, the processing in step S102 to step S108 is executed (step S600; No). In this case, in step S104, the controller 100 (the wireless function controller 106) disables the wireless connection with the other device such as the terminal device 20 by reducing or eliminating the intensity of the transmission output of the radio wave, which is output from the communicator 190. Then, in the wireless connection control processing in step S106, the controller 100 (the wireless function controller 106) makes the MFP 10 ready for the wireless connection with the other device such as the terminal device 20 by increasing the intensity of the transmission output of the radio wave, which is output from the communicator 190. Alternatively, the controller 100 (the wireless function controller 106) disables the wireless connection with the other device such as the terminal device 20 by reducing or eliminating the intensity of the transmission output of the radio wave, which is output from the communicator 190.

The processing illustrated in FIG. 12 is executed when the present embodiment is applied to the first embodiment. The present embodiment may be applied to the second embodiment. In such a case, in step S106 illustrated in FIG. 12, the controller 100 executes the wireless connection control processing illustrated in FIG. 7. Similarly, in the case where the present embodiment is applied to the third embodiment, in step S106 illustrated in FIG. 12, the controller 100 may execute the wireless connection control processing illustrated in FIG. 8. The present embodiment may also be applied to the fourth embodiment or the fifth embodiment.

Just as described, according to the MFP in the present embodiment, even in the case where the user enables the wireless function after the wireless function is disabled at the activation, it is possible to disable the wireless function at the timing at which the presence of the user can no longer be recognized. Accordingly, the MFP in the present embodiment can disable the wireless function at timing at which the wireless function becomes unnecessary, such as when the user moves away from the MFP. Thus, it is possible to avoid continuity of the state where the terminal device possessed by the user cannot receive the external communications. In addition, the MFP in the present embodiment disables the wireless function with the fact that the presence of the user is no longer recognized being a trigger. Therefore, even in the case where the user forgets to disable the wireless function after enabling the wireless function, it is possible to avoid the continuity of the state where the wireless function is enabled.

### 7. Seventh Embodiment

Next, a seventh embodiment will be described. In the seventh embodiment, the MFP in the first embodiment further has a sleep (low power mode) function and controls the wireless function.

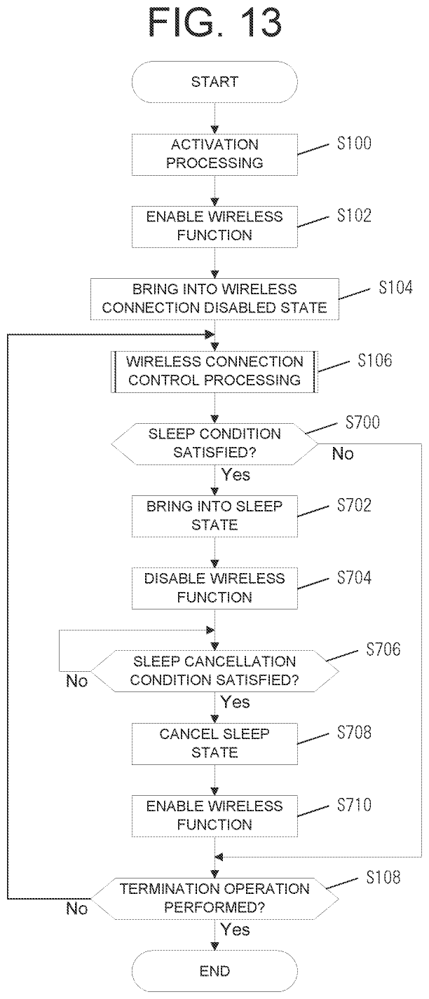

The present embodiment is implemented by replacing FIG. 4 in the first embodiment with FIG. 13. The same processing as that in the first embodiment will be denoted by the same reference sign, and the description thereon will not be made. In addition, the MFP 10 in the present embodiment includes required functional components among the functional components illustrated in FIG. 2 in the first embodiment.

The sleep function is a function that shifts the state of the MFP 10 from a normal operation state to a sleep state. The sleep state is a state where power consumption of the MFP 10 is suppressed by operating the MFP 10 at the low electric power, is also referred to as an energy-saving state. For example, the controller 100 brings the MFP 10 into the sleep state by stopping the electric power supply to some of the functional components of the MFP 10 or by reducing a magnitude of the electric power supply. The controller 100 may partially interrupt the operation of the MFP 10 at the time of shifting to the sleep state.

A condition at the time when the state of the MFP 10 is shifted from the normal operation state to the sleep state will be referred to as a sleep condition. Examples of the sleep condition are as follows:
That the MFP 10 does not receive the operation via the operation acceptor 150 for a predetermined period of time and does not receive a processing execution request from the other device for a predetermined period of time.
That a date and time for shifting to the predetermined sleep state come.
That an operation for shifting to the sleep state is performed.

A description will be made on a flow of main processing that is executed by the controller 100 with reference to FIG. 13. The processing illustrated in FIG. 13 is executed by the controller 100 in the case where the sleep function is enabled in the MFP 10.

After executing the wireless connection control processing, the controller 100 determines whether the sleep condition is satisfied (step S700). If the sleep condition is satisfied, the controller 100 brings the MFP 10 into the sleep state (step S700; Yes→step S702). Then, the controller 100 (the wireless function controller 106) disables the wireless function (step S704).

Next, the controller 100 determines whether a sleep cancellation condition is satisfied (step S706). The sleep cancellation condition is a condition to bring back the MFP 10 from the sleep state into the normal operation state. For example, the sleep cancellation condition is that the operation is input from the user.

If the sleep cancellation condition is satisfied, the controller 100 cancels the sleep state and brings back the MFP 10 into the normal operation state (a pre-sleep state) (step S706; Yes→step S708). Then, the controller 100 (the wireless function controller 106) enables the wireless function (step S710).

On the other hand, if the controller 100 determines in step S706 that the sleep cancellation condition is not satisfied, the processing in step S706 is repeated (step S706; No). In addition, if the controller 100 determines in step S700 that the sleep condition is not satisfied, the processing in step S702 to step S710 is omitted (step S700; No).

In the wireless connection control processing in step S106, the controller 100 (the wireless function controller 106) sets the transmission output of the radio wave, which is output from the communicator 190, while the wireless function remains enabled. In this way, the controller 100 (the wireless function controller 106) makes the MFP 10 ready for the wireless connection with the other device such as the terminal device 20, or disables the wireless connection. As a result, the controller 100 (the wireless function controller 106) can make the wireless function remain enabled when the MFP 10 is in the normal operation state. The controller 100 (the wireless function controller 106) can disable the wireless function only when the MFP 10 is in the sleep state. Therefore, in the sleep state, the MFP 10 can prohibit the wireless connection with the other device.

Just as described, the MFP in the present embodiment disables the wireless function in the sleep state. In this way, when the MFP is in the sleep state, it is possible to avoid the state where the terminal device possessed by the user cannot receive the external communications.

### 8. Eighth Embodiment

Next, an eighth embodiment will be described. In the eighth embodiment, in the case where a function, for which use of the wireless function is assumed, (a function for which establishment of the wireless connection is assumed) is provided, the wireless connection with the other device can be established only when such a function, for which use of the wireless function is assumed, is implemented.

The function, for which use of the wireless function is assumed, is a function that requires processing to establish the wireless connection with the other device and thereby exchange the information with the other device. An example of the function, for which use of the wireless function is assumed, is a mobile print function to receive image data stored in the terminal device 20 and form an image that is based on the image data. However, the function, for which use of the wireless function is assumed, may be a Scan to E-mail function or the facsimile function to acquire information on a destination, such as an e-mail address or a FAX number stored in the terminal device 20, and send scan data to the destination.

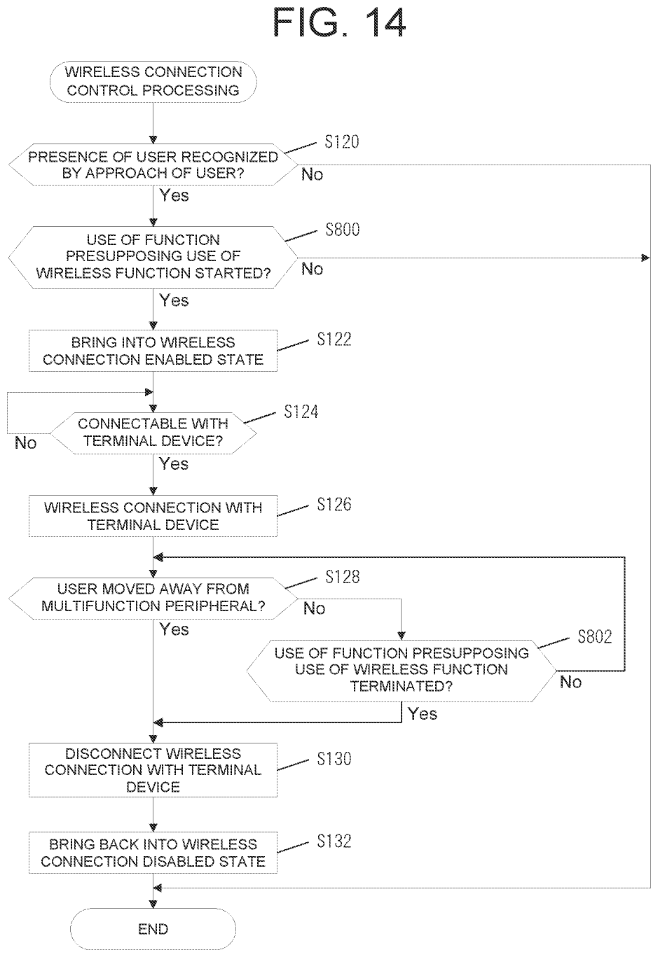

The present embodiment is implemented by replacing FIG. 4 in the first embodiment with FIG. 14. The same processing as that in the first embodiment will be denoted by the same reference sign, and the description thereon will not be made. In addition, the MFP 10 in the present embodiment includes required functional components among the functional components illustrated in FIG. 2 in the first embodiment.

A description will be made on a flow of the wireless connection control processing that is executed by the controller 100 with reference to FIG. 14. In the present embodiment, if the presence of the user is recognized by the approach of the user toward the MFP 10, the controller 100 determines whether use of the function, for which use of the wireless function is assumed, is started (step S800).

If the use of the function, for which use of the wireless function is assumed, is started, the controller 100 (the wireless function controller 106) makes the MFP 10 ready for the wireless connection with the terminal device 20 (step S800; Yes→step S122). In this way, when the use of the MFP 10 is started, and the use of the function, for which the use of the wireless function to establish the wireless connection with the other device such as the terminal device 20 is assumed, is started, the wireless function controller 106 can make the MFP 10 ready for the wireless connection with the other device.

Thereafter, if it is determined in step S128 that the user has not moved away from the MFP 10, the controller 100 determines whether the use of the function, for which the use of the wireless function is assumed, is terminated (step S802). For example, the controller 100 determines that the use of the function, for which the use of the wireless function is assumed, is terminated when the use of the function is terminated, such as when the processing, which is executed by the function whose use is started in step S800, is terminated or when input of the operation for the use of the function is terminated.

If the use of the function, for which the use of the wireless function is assumed, is terminated, the controller 100 disconnects the wireless connection with the terminal device 20 (step S802; Yes→step S130) and disables the wireless connection again (step S132). On the other hand, if the use of the function, for which use of the wireless function is assumed, is not terminated, the processing returns to step S128 (step S802; No→step S128).

If the controller 100 determines in step S800 that use of a function, for which the use of the wireless function is not assumed, is started, the processing illustrated in FIG. 4 is terminated (step S800; No). In this case, the MFP 10 remains in the state where the wireless connection with the other device cannot be established, and thus does not become ready for the wireless connection with the other device. In other words, even in the case where the user approaches the MFP 10, the wireless function controller 106 can keep disabling the wireless connection when the user uses the function, for which the use of the wireless connection is not assumed (the function that does not require the wireless communication with the other device).

The above description has been made on the case where the present embodiment is applied to the first embodiment. However, the present embodiment can also be applied to any embodiment from the second embodiment to the seventh embodiment. That is, in the present embodiment, the controller 100 (the wireless function controller 106) makes the MFP 10 ready for the wireless connection with the terminal device 20 in the case where the recognition device 104 recognizes the presence of the user and the use of the function, for which the use of the wireless function is assumed, is started. In this way, even in the case where the presence of the user is recognized, the controller 100 (the wireless function controller 106) can keep disabling the wireless connection when the function, for which the use of the wireless function is assumed, is not used.

For example, it is assumed that the MFP 10 has the mobile print function to acquire the image data from the terminal device 20 and output the image based on the image data via the image forming device 130. In this case, when the user selects to use the mobile print function, the controller 100 (the wireless function controller 106) makes the MFP 10 ready for the wireless connection with the other device such as the terminal device 20. Thereafter, the controller 100 (the wireless function controller 106) disables the wireless connection of the MFP 10 with the other device such as the terminal device 20 at timing at which the wireless connection becomes unnecessary, for example, when the use of the mobile print function is terminated. In this way, the MFP 10 can be wirelessly connected to the terminal device 20 only while the mobile print function is used.

Just as described, the MFP in the present embodiment can bring the transmission output of the radio wave for the wireless function into the normal state when the function, for which the use of the wireless function is assumed, is used. Then, when the use of such a function is terminated, the MFP in the present embodiment can eliminate the transmission output of the radio wave for the wireless function or reduce the transmission output of the radio wave for the wireless function to be extremely low (the state of being unconnectable with the other device) again. In this way, the MFP in the present embodiment can keep disabling the wireless connection when the use of the function, for which the use of the wireless function is not assumed, is started. Therefore, it is possible to further shorten a period in which the terminal device used by the user is wirelessly connected to the MFP.

### 9. Modification Examples

The present disclosure is not limited to the embodiments described above, and various modifications may be made thereto. That is, the technical scope of the present disclosure also includes embodiments that may be obtained by combining technical measures that are modified as appropriate without departing from the gist of the present disclosure.

Although some parts of the above-described embodiments are separately described for convenience of the description, it is needless to say that the embodiments may be combined and implemented within a technically allowable range. That is, some of the control methods for the wireless function described in the above embodiments may be combined to control the wireless function.

For example, the first and second embodiments may be combined. In this case, the MFP becomes ready for the wireless connection with the other device when the approach of the user or the other device using the near-field communication means is detected. Meanwhile, the MFP disables the wireless connection with the other device when the movement of the user away from the MFP is detected or the other device using the near-field communication means cannot be detected. The first and third embodiments may be combined, or the first and fourth embodiments may be combined. The first and fifth embodiments may be combined, or the second and third embodiments may be combined.

In this case, the MFP can be ready for the wireless connection with the other device by using the near-field communication means and the authentication means when the terminal device possessed by the user is located around the MFP and the user has logged into the MFP.

The above-described combination is merely an example, and two or more of the embodiments may be combined. In other words, the description has been made in each of the embodiments that the wireless connection with the other device is enabled when the presence of the user is recognized. Thus, based on the above-described embodiments, the cases where the wireless connection with the other device is enabled when the presence of the user is recognized may appropriately be combined.

In the above embodiments, the description has been made on the case where the information processing apparatus according to the present disclosure is applied to the MFP. However, the information processing apparatus according to the present disclosure can also be applied to a device (such as the scanner, the laser printer, or the like) that is directly and wirelessly connected to the terminal device and exchanges information with the terminal device.

The program that is operated on each of the devices in the embodiments is a program that controls the CPU or the like (a program that makes a computer function) so as to implement the functions of the above-described embodiments. The information handled by these devices is temporarily accumulated in a temporary storage device (for example, RAM)) during processing, is then stored in various storage devices such as read only memory (ROM) and an HDD, and is read, corrected, and written by the CPU as needed.

Here, a recording medium that stores the program may be, for example, any of a semiconductor medium (for example, ROM or a non-volatile memory card), an optical recording medium/magneto-optical recording medium (for example, a digital versatile disc (DVD), a magneto optical disc (MO), a Mini Disc (MD), a compact disc (CD), and a Blu-ray® disc (BD)), and a magnetic recording medium (for example, a magnetic tape or a flexible disk). In addition, the functions of the above-described embodiments may be implemented by executing a loaded program. In some cases, the functions of the present disclosure are implemented by processing in collaboration with the operating system or another application program on the basis of the instructions of the program.

Furthermore, when the program is to be distributed to the market, the program may be stored in a portable recording medium for distribution or may be transferred to a server computer connected via a network such as the Internet. In this case, a storage device of the server computer is also included in the present disclosure as a matter of course.

What is claimed is:

1. An information processing apparatus comprising:
a communicator that is wirelessly connected to another device for direct wireless communication with the other device;
a recognition device that recognizes presence of a user; and
a controller that controls transmission output of a radio wave output from the communicator, so as to enable wireless connection with the other device at the time when the presence of the user is recognized and to disable the wireless connection with the other device at the time when the presence of the user is no longer recognized.

2. The information processing apparatus according to claim 1 further comprising:
a detector that detects the user, wherein
the recognition device recognizes the presence of the user when the user is detected by the detector.

3. The information processing apparatus according to claim 1 further comprising:
a near-field communicator that makes near-field communication by a near-field communication method, wherein
the recognition device recognizes the presence of the user when the other device is recognized by the near-field communicator.

4. The information processing apparatus according to claim 1, wherein
the recognition device recognizes the presence of the user in a period from time at which the user logs in to time at which the user logs off.

5. The information processing apparatus according to claim 1, wherein
the recognition device recognizes the presence of the user in a period from time at which an operation to perform a task is started to time at which the operation to execute the task is completed.

6. The information processing apparatus according to claim 5 further comprising:
a display processor that executes processing to display an identification code indicating information used for the wireless connection, wherein
the recognition device sets time at which an operation to display the identification code is performed as the time at which the operation to execute the task is started.

7. The information processing apparatus according to claim 5 further comprising:
a reader that reads an identification code, wherein
the recognition device sets:
time at which the identification code is read as the time at which the operation to execute the task is started; and
time at which the task indicated by the identification code is completed as the time at which the operation to execute the task is completed.

8. The information processing apparatus according to claim 1, wherein
the controller:
disables the wireless connection with the other device by reducing or eliminating the transmission output of the radio wave, which is output from the communicator, while a wireless function to establish the wireless connection with the other device through the communicator remains enabled; and
enables the wireless connection with the other device by increasing the transmission output of the radio wave, which is output from the communicator.

9. The information processing apparatus according to claim 8, wherein
the controller:
disables the wireless function when the information processing apparatus is brought into a sleep state; and
enables the wireless function when the information processing apparatus is resumed from the sleep state.

10. The information processing apparatus according to claim 1, wherein
the controller disables the wireless connection with the other device in the case where the presence of the user is no longer recognized after the user performs an operation to enable the wireless connection.

11. The information processing apparatus according to claim 1, wherein
the controller enables the wireless connection with the other device only when the presence of the user is recognized and the user selects to execute the task, for which establishment of the wireless connection is assumed.

12. A control method for an information processing apparatus that is wirelessly connected to another device for direct wireless communication with the other device, the method comprising:
recognizing presence of a user; and
controlling transmission output of a radio wave, so as to enable wireless connection with the other device at the time when the presence of the user is recognized and to disable the wireless connection with the other device at the time when the presence of the user is no longer recognized.
